(19) United States
(12) Patent Application Publication
(10) Pub. No.: US 2015/0286701 A1
(43) Pub. Date: Oct. 8, 2015

(54) Data Classification Aware Object Storage

(71) Applicant: Quantum Corporation, San Jose, CA (US)

(72) Inventor: Rod Wideman, Shakopee, MN (US)

(73) Assignee: Quantum Corporation, San Jose, CA (US)

(21) Appl. No.: 14/244,935

(22) Filed: Apr. 4, 2014

(51) Int. Cl. G06F 17/30

(52) U.S. Cl. CPC G06F 17/30598

(57) ABSTRACT

Example apparatus and methods process data that is going to be stored in an object store. The object store may have multiple data destinations (e.g., “buckets”). Different buckets have different data storage policies that control, for example, how many copies of the data will be made, whether the data will be stored onsite or offsite, or other storage parameters. Data may be classified by identifying a value for an attribute (e.g., file type, file source) of the data. A storage policy associated with a bucket may then be selected based on the attribute. Once the storage policy has been selected, then the data may be provided to a bucket associated with the storage policy. The number of buckets, data classifications, or storage policies may be updated by adaptive parameterization that considers the amount or type of data observed and stored in the object store.

### BACKGROUND

An object store, which may also be referred to as an object based storage system, may have multiple devices (e.g., disks) in multiple apparatus (e.g., servers) positioned at multiple locations (e.g., sites). An object store may be controlled with respect to where any given piece of data (e.g., block, file, erasure code) is stored or with respect to where any given collection of data is stored. An object store may be able to store different numbers of copies of a given piece of data, may selectively compress data, may selectively encrypt data, may selectively distribute data, or may perform other selective actions. Conventionally, which, if any, selective actions (e.g., compression, encryption) are performed may have been controlled by a user specifying an action or set of actions for a particular object store as a whole.

File systems store files and store information about files. The information stored in files may be referred to as data. The information about files may be referred to as metadata. The metadata may include, for example, a file name, a file size, and other information. Some of the metadata for an individual file may be stored in a data structure known as an inode. The inodes and metadata for a file system may be stored collectively.

Object storage is distinguished from other traditional storage types (e.g., file system, block storage) by the object store being responsible for the placement of data. An application or client may provide data to an object store, and then the object store may decide where and how to store the data on the underlying storage media. In contrast, file systems organize and manage the placement of data on, for example, block storage devices (e.g., disk drives). File systems are responsible for maintaining the block addressing associated with the placement of data on block storage devices.

Object stores are responsible for the placement of data. Object stores are also responsible for the protection of data. Thus, an object store may provide a configurable policy that controls the number of copies of data that are stored, whether the copies are all stored onsite or whether some copies are stored offsite, whether data is compressed, whether data is encrypted, or other actions. A single, uniform instance of the data may be provided to an application or client.

Unfortunately, object storage systems may treat data in an opaque manner while a single approach to protection is employed. While this single approach may provide benefits to conventional systems, the single approach may produce sub-optimal performance. For example, some types of data may be under-protected (e.g., not enough copies, no off-site backup) and other types of data may be over-protected (e.g., too many copies). One conventional attempt to deal with the over/under protected problem produced by single-approach object stores is to use multiple single-approach object stores. However, having two or more single-approach object stores places additional burdens on applications or clients. For example, an application or client may need to know the different policies in place on the different object stores and may need to be able to send data to an appropriate object store. Additionally, an object store designer or manager would need to decide ahead of time what policy to put in place for each of the single-approach object stores.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an external data classifier associated with a data classification aware object store.

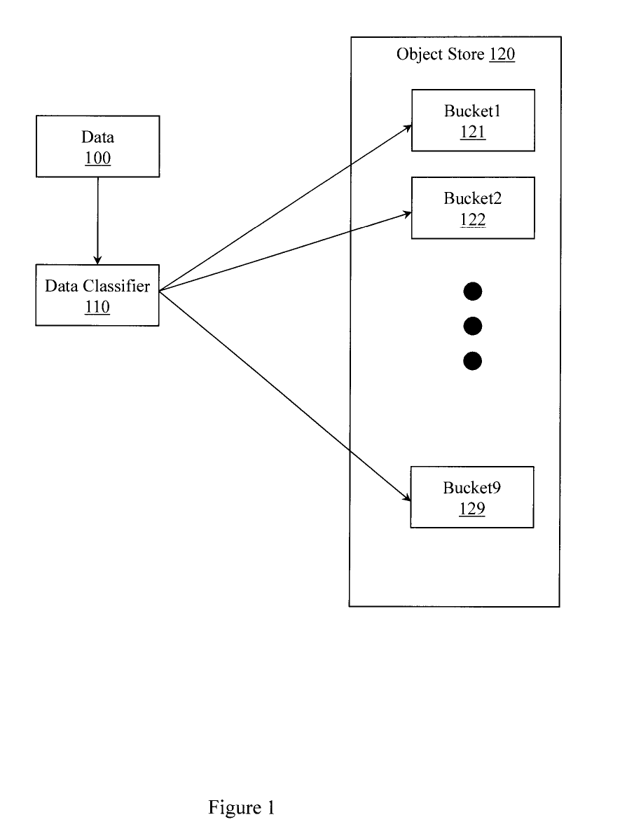

FIG. 2 illustrates an internal data classifier in a data classification aware object store.

FIG. 3 illustrates an integrated in-line data classifier in a data classification aware object store.

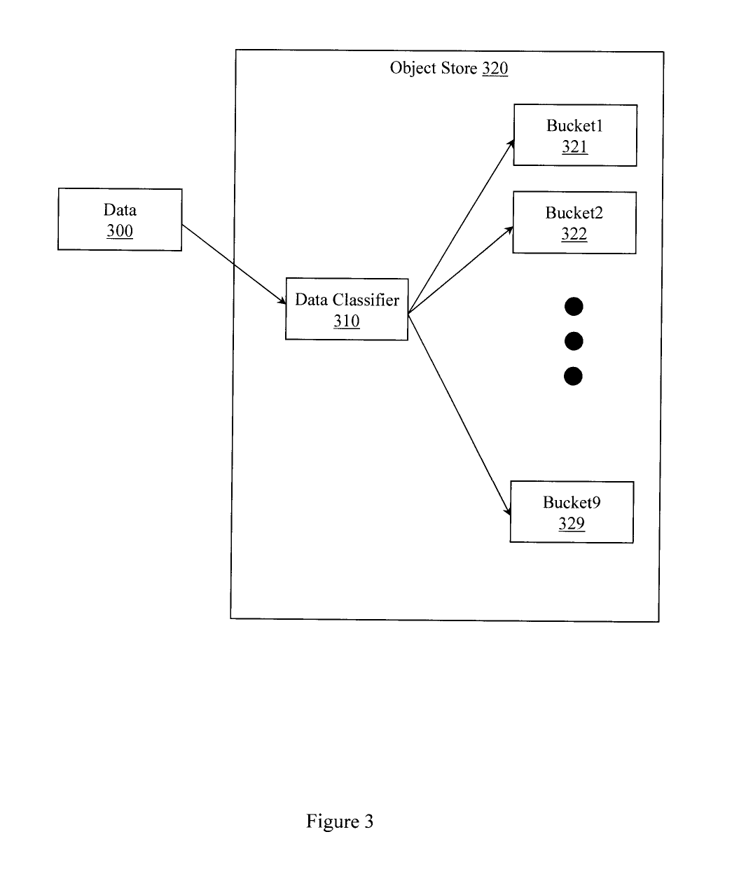

FIG. 4 illustrates dynamically adding or removing a bucket associated with a namespace and policy to or from an object store.

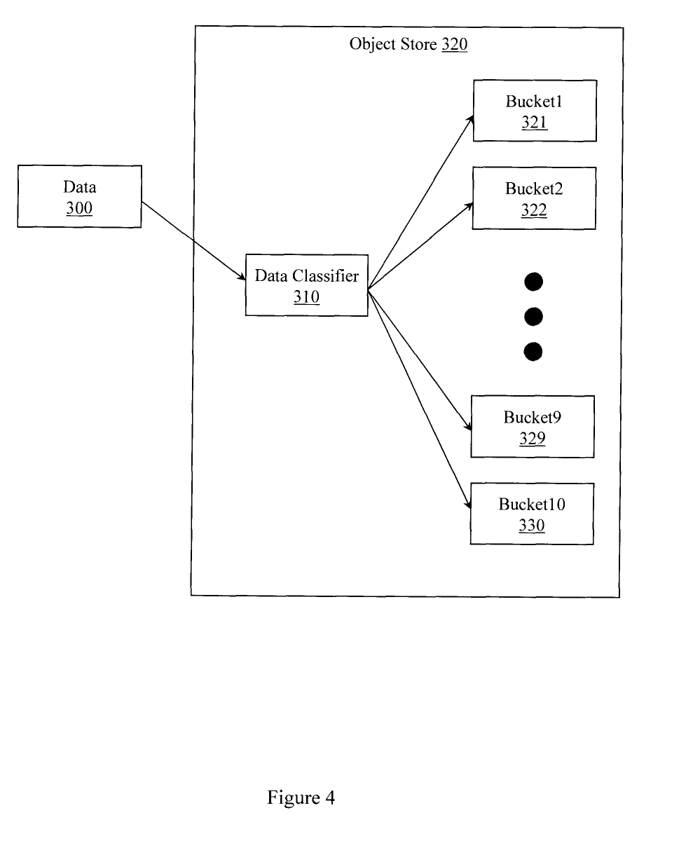

FIG. 5 illustrates different policies associated with different namespaces.

FIG. 6 illustrates an example method associated with a data classification aware object store.

FIG. 7 illustrates an example method associated with a data classification aware object store.

FIG. 8 illustrates an example apparatus associated with a data classification aware object store.

FIG. 9 illustrates an example apparatus associated with a data classification aware object store.

### DETAILED DESCRIPTION

Example apparatus and methods provide data classification aware object storage. Rather than providing an opaque, single-approach object store, example apparatus and methods use data classification or content awareness to provide a transparent, multi-policy approach object store. Data classification or content awareness may be provided using different approaches.

Figure one illustrates data 100 being provided to a data classifier 110 that is located external to an object store 120. Being located “external” to the object store 120 means that data classifier 110 operates on data in a namespace that is supervised or administered by an entity other than the object store 120. “Namespace” is used in its computer science meaning and thus refers to an abstract container or environment created to hold a logical grouping of unique identifiers, symbols (e.g., names), or items. An identifier defined in a namespace is associated only with that namespace. The same identifier can be independently defined in multiple namespaces. Data storage devices may support namespaces.

Object store 120 may have a number of different “buckets” that will apply different policies to data directed to the bucket. A bucket may be addressed using a namespace associated with the bucket, thus the object store 120 may expose multiple namespaces to the data classifier 110. Data classifier 110 may examine the data 100 presented to it and may recognize content including, for example, files and metadata. The data classifier 110 may identify the start or end of files, may identify the start or end of metadata associated with files, may examine the contents of files, or may take other actions. The data classifier 110 may then identify one or more parameters for a file based on the metadata, file content, or other file attributes (e.g., size). The data classifier 110 may then steer a file to a namespace, and thus to a bucket or data destination, based on the parameters associated with the file. For example, a file for which a first number of copies is to be made may be directed to a first namespace while a file for which a second number of copies is to be made may be directed to a second namespace. Similarly, a file that is to be encrypted may be directed to one namespace while a file that is to be compressed may be directed to another namespace. An application or client that provides data 100 to data classifier 110 may not need to be aware of the policies, namespaces, or buckets available in the object store 120. In one embodiment, the data classifier 110 may provide data directly to an appropriate bucket in object store 120. In another embodiment, data classifier 110 may move data that has been classified to an intermediate storage (e.g., network attached storage (NAS)). A separate application (e.g., backup, archive) may then move the data that was classified and stored in the intermediate storage to an appropriate bucket in the object store 120.

An object store, which may perform object-based storage, provides a storage architecture that manages data as objects. A file system may manage data using a file hierarchy. A disk or other block-based device may use a block storage approach that manages data as blocks with sectors in tracks. An object store may store objects, where an object includes, for example, data to be stored, metadata about the data, a globally unique identifier, or other information. An object store may be implemented at different levels including, for example, at a device level that includes an object storage device, at a system level, at an interface level, or at other levels. An object store may provide capabilities including, for example, interfaces that may be directly programmable by an application, a namespace or namespaces that can span multiple instances of physical hardware, data replication at object-level granularity, data distribution at object-level granularity, or other capabilities. An object store is not a file system.

Figure two illustrates data 200 being provided to a data classifier 210 that is located internal to an object store 220. Being “internal” to the object store means that data classifier 210 operates on data in a namespace that is supervised or administered by the object store 220. Data 200 is not provided directly to data classifier 210 but is first stored in a general bucket 205. General bucket 205 may be, for example, a temporary data store (e.g., network attached storage (NAS), memory, disk, tape) associated with object store 220. Object store 220 may have a number of different buckets that will apply different policies to data directed to the bucket. A bucket may be addressed using a namespace associated with the bucket. In this embodiment, since data 200 is provided to a general bucket 205, the object store 220 may only expose a single namespace externally while still exposing multiple namespaces to the data classifier 210. Data classifier 210 may examine the data presented to it and may recognize content including, for example, files and metadata. The data classifier 210 may identify the start or end of files, may identify the start or end of metadata associated with files, may examine the contents of files, or may take other actions. The data classifier 210 may then identify one or more parameters for a file based on the metadata, file content, or other file attributes (e.g., size). The data classifier 210 may then steer a file to a namespace based on the parameters associated with the file. For example, a file for which onsite copies only are to be made may be directed to a first namespace while a file for which both onsite and offsite copies are to be made may be directed to a second namespace. Directing a file to a namespace causes the file to be sent to a bucket or data destination associated with the namespace. An application or client that provides data 200 to general bucket 205 may not need to be aware of the policies or namespaces available in the object store 220. In one embodiment, the data classifier 210 may provide data directly to an appropriate bucket in object store 220. In another embodiment, data classifier 210 may move data that has been classified to an intermediate storage. A separate application, process, or thread may then move the data that was classified and stored in the intermediate storage to an appropriate bucket in the object store 220. In one embodiment, the separate application, process, or thread may be a background process or secondary process. The background or secondary process may operate periodically, upon determining that a threshold amount of data is ready to be moved to a bucket, or upon detecting other triggers.

Figure three illustrates data 300 being provided to an integrated in-line data classifier 310 that is located internal to an object store 320. Data 300 is provided directly to data classifier 310. Object store 320 may have a number of different buckets that will apply different policies to data directed to the different buckets. A bucket may be addressed using a namespace associated with the bucket. In this embodiment, since data 300 is provided to data classifier 310, the object store 320 may only expose a single namespace externally while still exposing multiple namespaces to the data classifier 310.

Data classifier 310 may examine the data 300 and may recognize content including, for example, files and metadata. The data classifier 310 may identify the start or end of files or other items, may identify the start or end of metadata associated with files or other items, may examine the contents of files or other items, or may take other actions. The data classifier 310 may then identify a parameter(s) for a file or other item in the data 300 based on the metadata, file content, or other file attributes (e.g., size). The data classifier 310 may then steer a file or other item to a namespace based on the parameters associated with the file. Data classifier 310 may consider, for example, Internet media types, MIME types, POSIX file attributes, or other attributes. A media type may include, for example a type, a subtype, and optional parameters. For example, an HTML (hypertext markup language) file might be designated text/html; charset=UTF-8. In this example text is the type, html is the subtype, and charset=UTF-8 is an optional parameter indicating the character encoding. MIME (Multipurpose Internet Mail Extensions) file types may also be referred to as content types. POSIX (Portable Operating System Interface) refers to a family of standards specified by the IEEE for maintaining compatibility between operating systems. Other attributes may include, for example, the origin of the data (e.g., user, application), the velocity of the data (e.g., the rate at which the data is being generated), the age of the data, or other attributes.

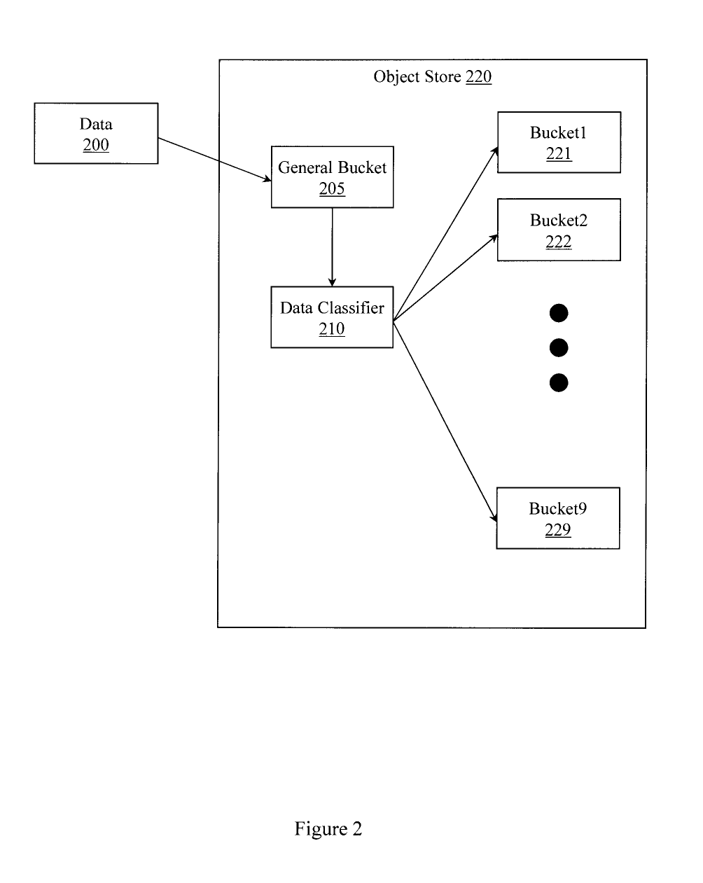

Rather than reading data 300 from a data store like classifier 210 (FIG. 2), data classifier 310 may analyze and classify data 300 as it is received and may steer data 300 to a bucket as the data 300 is classified. The level of integration exhibited by integrated in-line data classifier 310 may facilitate, for example, adaptive parameterization where different levels of protection are made available for different classifications of data, or where the protection available for a particular classification of data is changed.

Figure four illustrates an additional bucket (e.g., bucket10, 330) that has been added to object store 320. A bucket may be added to or removed from object store 320 in response to, for example, user control, application control, or programmatic control. In one embodiment, a user may examine the policies available in object store 320 and cause a new policy and new namespace to be created. For example, a user may realize that the object store 320 has been handling five classifications but a sixth classification for a new or different type of data is warranted. In one embodiment, an application may determine that some data it is providing to object store 320 ought to be protected with a different level of protection than object store 320 is currently providing. Therefore the application may ask or direct object store 320 to produce a new policy and namespace. In one embodiment, object store 320 may determine that a new policy and namespace are warranted or that an existing policy and namespace are not warranted. For example, object store 320 may determine that substantially all data is being stored in one namespace and that two or three existing namespaces are not being used at all. In this case, one of the under-utilized namespaces and policies may be removed. Additionally, adaptive parameterization may occur and a finer grained policy that will cause some of the data that is currently being sent to the over-utilized namespace to be directed to the new namespace associated with the finer-grained policy. For example, two policies may have been in place, a first policy for data that was to have just onsite backups and a second policy for data that was to have both onsite and offsite backups. A finer-grained policy may be provided that distinguishes between data that is going to have just onsite backups with more than two copies and data that is going to have just onsite backups with two or less copies.

As used herein, “bucket” refers to a logical storage entity. Portions of a single bucket may reside on multiple storage devices. A storage device may store data for one or more buckets. Data stored in a bucket may be accessed using a unique namespace. A bucket may have its own data storage policy. Buckets and data storage policies may have been pre-configured by an object store manager or may have evolved over time in response to data observed and stored by the object store.

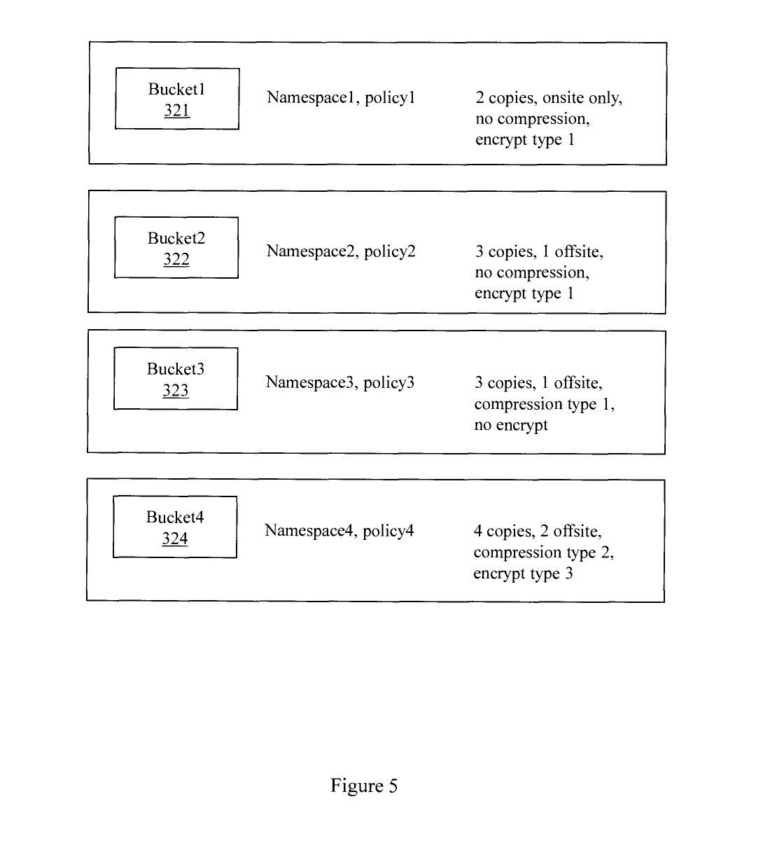

FIG. 5 illustrates four different buckets associated with four different namespaces and four different policies. Bucket1 321 has a first namespace (e.g., namespace1) and a first policy (e.g., policy1). Policy1 specifies that two copies will be made for data provided to bucket1 321. Additionally, policy1 specifies that the copies will be kept onsite only, that the data will not be compressed, and that the data will be encrypted using encryption type 1. Bucket2 322 has a second namespace (e.g., namespace2) and a second policy (e.g., policy2). Policy2 specifies that three copies will be made for data provided to bucket2 322. Additionally, policy2 specifies that one of the copies will be kept offsite, that the data will not be compressed, and that the data will be encrypted using encryption type 1. Bucket3 323 has a third namespace (e.g., namespace3) and a third policy (e.g., policy3). Policy3 specifies that three copies will be made for data provided to bucket3 323. Additionally, policy3 specifies that one of the copies will be kept offsite, that the data will be compressed using compression type 1, and that the data will not be encrypted. Bucket4 324 has a fourth namespace (e.g., namespace4) and a fourth policy (e.g., policy4). Policy4 specifies that four copies will be made for data provided to bucket4 324. Additionally, policy4 specifies that two of the copies will be kept offsite, that the data will be compressed with compression type 2, and that the data will be encrypted using encryption type 3. While figure five illustrates four different buckets with four different policies, example apparatus and methods may provide a greater or lesser number of buckets with a greater or lesser number of policies. Additionally, while the illustrated policies concern number of copies, onsite/offsite, compression, and encryption, other policies may include a greater or lesser number of parameters and may include additional or different parameters (e.g., preferred storage media).

Some portions of the detailed descriptions herein are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated. The physical manipulations create a concrete, tangible, useful, real-world result.

It has proven convenient at times, principally for reasons of common usage, to refer to these signals as bits, values, elements, symbols, characters, terms, or numbers. It should be borne in mind, however, that these and similar terms are to be associated with the appropriate physical quantities and are merely convenient labels applied to these quantities. Unless specifically stated otherwise, it is to be appreciated that throughout the description, terms including processing, computing, and determining refer to actions and processes of a computer system, logic, processor, or similar electronic device that manipulates and transforms data represented as physical (electronic) quantities.

Example methods may be better appreciated with reference to flow diagrams. For purposes of simplicity of explanation, the illustrated methodologies are shown and described as a series of blocks. However, it is to be appreciated that the methodologies are not limited by the order of the blocks, as some blocks can occur in different orders or concurrently with other blocks from that shown and described. Moreover, less than all the illustrated blocks may be required to implement an example methodology. Blocks may be combined or separated into multiple components. Furthermore, additional or alternative methodologies can employ additional, not illustrated blocks.

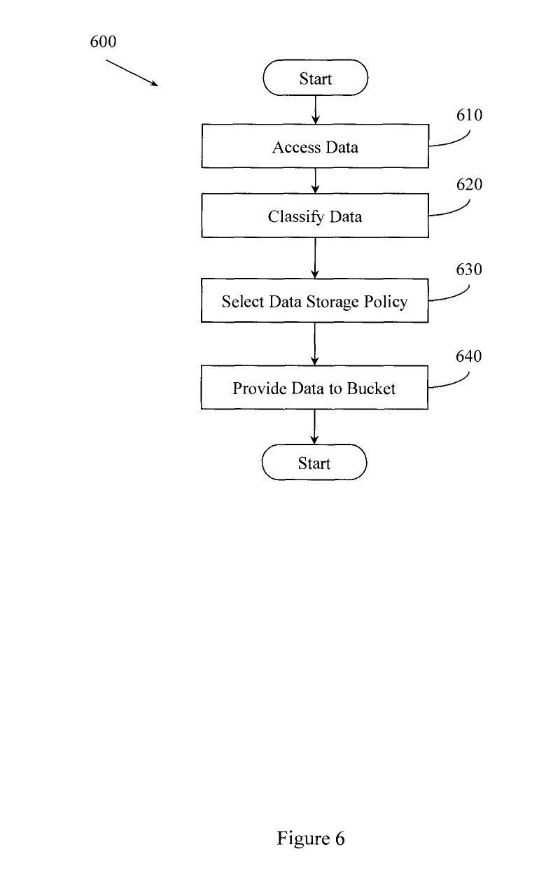

FIG. 6 illustrates a method 600 associated with a data classification aware object store. Method 600 includes, at 610, accessing data that is to be stored in an object store that is configured with two or more data destinations. A data destination may be, for example a “bucket” that has a unique namespace and a data storage policy. A data destination may store data in one or more data stores or devices.

Method 600 also includes, at 620, classifying the data by identifying a value for an attribute of the data. In one embodiment, classifying the data by identifying the value for the attribute includes examining metadata associated with the data or examining the contents of the data. The attribute may be, for example, a file type, a file size, a file owner, an origin of the data, an age of the data, a velocity of the data, or other attribute. The origin of the data may describe, for example, a user, application, process, or apparatus from which the data was received. The velocity of the data may describe, for example, the rate at which the data is being produced.

Data destinations have unique namespaces. In one embodiment, classifying the data is performed in an apparatus located external to the object store. In this embodiment, the object store exposes two or more namespaces to the apparatus located external to the object store. For example, the namespaces of all the buckets in the object store may be exposed to the apparatus that is performing the classification. In another embodiment, classifying the data is performed in an apparatus located internal to the object store. In this embodiment, the object store exposes two or more namespaces to the apparatus located internal to the object store but may only expose a single namespace to apparatus located outside the object store. In another embodiment, classifying the data is performed in-line in an apparatus integrated into the object store. In this embodiment, the object store exposes two or more namespaces to the apparatus integrated into the object store but only exposes a single namespace to apparatus located outside the object store.

Method 600 also includes, at 630, selecting a data storage policy associated with a member of the two or more data destinations. Which storage policy is selected may be based, at least in part, on the value of the attribute. For example, a first policy may be selected for data that is of a first file type and above a first file size, a second policy may be selected for data that is of a certain age, and a third policy may be selected for data that is being produced above a threshold rate. The data storage policy may describe, for example, a number of copies to be made of the data, whether the data is to be stored onsite, whether the data is to be stored offsite, whether the data is to be compressed, a type of compression to be performed on the data, whether the data is to be encrypted, or a type of encryption to be performed on the data. In one embodiment, the data storage policy controls whether the data will be stored using erasure codes. In one embodiment, when the data is stored using erasure codes, the data storage policy may control a parity level used with erasure code based storage. The data storage policy may dictate that a greater or lesser amount of parity protection be used with the erasure code. Manipulating the parity associated with the erasure code facilitates controlling how many erasures are to be guarded against.

Method 600 also includes, at 640, providing the data to a member of the two or more data destinations that is associated with the data storage policy. In one embodiment, providing the data to the member (e.g., bucket) includes providing the data directly to the member. For example, the data may be provided to the member through a function call, by a computer network communication, by writing to a memory accessible to the member, or in other direct ways. In one embodiment, providing the data to the member includes sending the data indirectly via an intermediate data store. For example, the data may be written to a network attached storage (NAS) from which the member may then read the data. In this embodiment, method 600 may include controlling a separate process to move the data from the intermediate data store to the member. The separate process may be triggered in different ways. For example, the separate process may be triggered periodically, upon determining that a threshold amount of data is being stored in the intermediate data store, or in other ways.

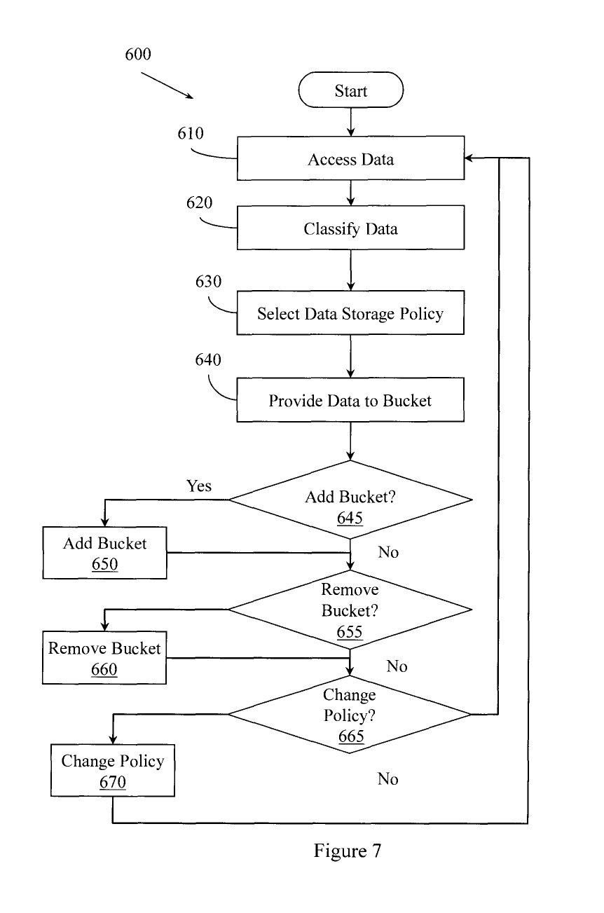

FIG. 7 illustrates another embodiment of method 600. This embodiment of method 600 also includes, at 650, selectively adding a new data destination to an object store. The new bucket may be added to the object store if the determination at 645 is Yes. The determination at 645 may be based, for example, on utilization levels for buckets, on the appearance of a new type of data, or on other factors. For example, a new type of data that requires encryption may be encountered and no buckets may currently be providing encryption. Therefore a new bucket that offers encryption may be added. Adding the new data destination may include providing an additional data storage policy associated with the new data destination. Method 600 may also include, at 660, selectively removing a data destination from the object store. The data destination may be removed if the determination at 655 is Yes. The determination at 655 may be based, for example, on utilization levels for buckets, on the non-appearance of an anticipated type of data, or on other factors. A bucket may be removed if, for example, no data has ever been stored in the bucket. Removing the data destination may include deactivating a data storage policy associated with the data destination being removed.

This embodiment of method 600 may also include, at 670, selectively modifying a data storage policy. The policy may be modified if the determination at 665 is Yes. The determination at 665 may be based on observations of data that is actually being stored and the policies available to store that data. The data storage policy may be updated based, at least in part, on an observation of a threshold amount of data that has been stored in the object store. For example, if more than fifty percent of all the data stored in the object store is stored using a first data storage policy, then two finer-grained storage policies may be established to distribute the data to different buckets. In another example, if less than one percent of all the data stored in the object store is stored using a certain data storage policy, then that data storage policy may be broadened or eliminated.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and other similar terms, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable storage medium”, as used herein, refers to a non-transitory medium that stores instructions and/or data. A computer-readable medium may take forms, including, but not limited to, non-volatile media, and volatile media. Non-volatile media may include, for example, optical disks, magnetic disks, and other disks. Volatile media may include, for example, semiconductor memories, dynamic memory, and other memories. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Data store”, as used herein, refers to a physical and/or logical entity that can store data. A data store may be, for example, a database, a table, a file, a data structure (e.g. a list, a queue, a heap, a tree) a memory, a register, or other repository. In different examples, a data store may reside in one logical and/or physical entity and/or may be distributed between two or more logical and/or physical entities.

“Logic”, as used herein, includes but is not limited to hardware, firmware, software in execution on a machine, and/or combinations of each to perform a function(s) or an action(s), and/or to cause a function or action from another logic, method, and/or system. Logic may include, for example, a software controlled microprocessor, a discrete logic (e.g., ASIC), an analog circuit, a digital circuit, a programmed logic device, or a memory device containing instructions. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, or logical communications may be sent or received. An operable connection may include a physical interface, an electrical interface, or a data interface. An operable connection may include differing combinations of interfaces or connections sufficient to allow operable control. For example, two entities can be operably connected to communicate signals to each other directly or through one or more intermediate entities (e.g., processor, operating system, logic, software). Logical or physical communication channels can be used to create an operable connection.

“Signal”, as used herein, includes but is not limited to, electrical signals, optical signals, analog signals, digital signals, data, computer instructions, processor instructions, messages, a bit, or a bit stream, that can be received, transmitted and/or detected.

“Software”, as used herein, includes but is not limited to, one or more executable instructions that cause a computer, processor, or other electronic device to perform functions, actions and/or behave in a desired manner. “Software” does not refer to stored instructions being claimed as stored instructions per se (e.g., a program listing). The instructions may be embodied in various forms including routines, algorithms, modules, methods, threads, or programs including separate applications or code from dynamically linked libraries.

“User”, as used herein, includes but is not limited to one or more persons, software, logics, applications, computers or other devices, or combinations of these.

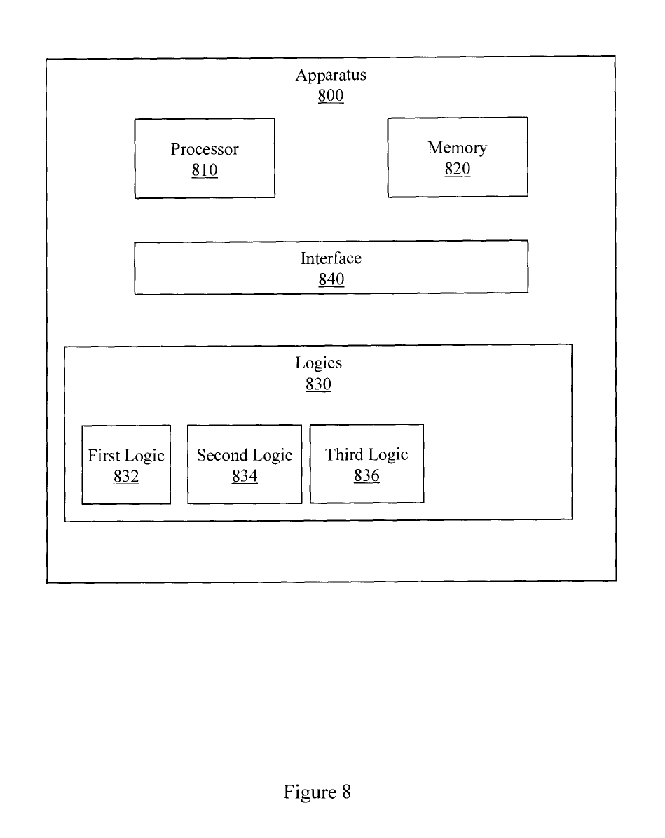

FIG. 8 illustrates an apparatus 800 that includes a processor 810, a memory 820, and a set 830 of logics that is connected to the processor 810 and memory 820 by an interface 840. In one embodiment, the apparatus 800 may be an object storage system or object store. In one embodiment, the apparatus 800 may be operably connected to or in data communication with an object storage system or object store. Recall that an object storage system performs object-based storage using a storage architecture that manages data as objects instead of, for example, as files. An object store is not a file system. An object store is not just a backup appliance like a tape drive, tape library, or disk drive. “Object”, as used herein, refers to the usage of object in computer science. From one point of view, an object may be considered to be a location in a physical memory having a value and referenced by an identifier.

In one embodiment, the set 830 of logics cause an object store to protect data with different levels of protection. For example, some data may be protected with two copies while other data may be protected with a number of copies that facilitate tolerating the loss of several storage devices (e.g., disks). Additionally, some data may be stored with on-premise copies only while other data may be stored with off-premise copies. In one embodiment, the set 830 of logics operate to allow an object store to selectively compress data. Some data types are known to be unsuitable for compression. Selectively bypassing compression for uncompressible data may save significant resources because compression may be an expensive operation in terms of processing power, time, memory, or other resources. In one embodiment, the set 830 of logics operate to allow an object store to selectively encrypt data. Like compression, encryption may be an expensive operation in terms of processing power, time, memory, or other resources. The set 830 of logics may facilitate adaptively creating new buckets. New buckets may be created in response to, for example, identifying new types or volumes of data being received. Thus, rather than having to create buckets in advance, an object store manager can allow the object store to adaptively create new buckets. The set 830 of logics may also facilitate modifying policies over time. For example, as the types or volumes of data being encountered are analyzed, policies may be modified (e.g., made more finer-grained, made more coarser-grained) to account for the new or different usage patterns associated with observed data classifications.

The set of logics 830 may control storage of data in an object store configured with two or more buckets. The set of logics 830 may cause an item to be stored in a member of the two or more buckets. A bucket may be selected to store the item based, at least in part, on a set of data classifications that relate the item and the bucket.

The set 830 of logics may include a first logic 832 that produces a classification of the item to be stored by the object store. In one embodiment, the first logic 832 produces the classification from the contents of the item or from metadata associated with the item. In different embodiments, the classification may be performed outside the object store or inside the object store. In different embodiments, the classification may be made inline on data as it is received or may be made from a buffer that stores data for later classification.

The apparatus 800 may also include a second logic 834 that selects a bucket from the two or more buckets. Which bucket is selected may be based, at least in part, on the classification of the item. For example, an item of a first type (e.g., word processing file) may be stored in a first bucket while an item of a second type (e.g., movie file) may be stored in a second bucket. In one embodiment, the second logic 834 selects the bucket by matching the classification to storage parameters associated with members of the two or more buckets.

The apparatus 800 may also include a third logic 836 that controls how the item is to be provided to the bucket. In one embodiment, the third logic 836 controls the item to be provided to the bucket indirectly via a network attached storage (NAS) or other storage apparatus. In another embodiment, the third logic 836 controls the item to be provided directly to the bucket by, for example, a direct memory transfer, a write to a shared memory, by streaming data to the bucket, by adding the data to a socket connected to the bucket, or in other ways.

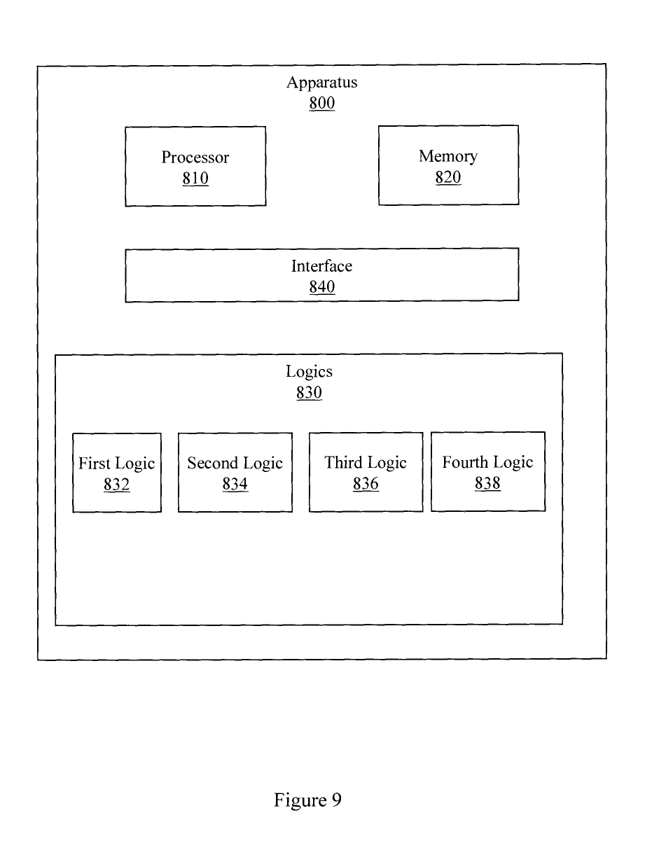

FIG. 9 illustrates another embodiment of apparatus 800. This embodiment includes a fourth logic 838. The fourth logic 838 may selectively reconfigure the number of buckets available in the object store. The fourth logic 838 may reconfigure the number of buckets upon determining that a threshold number of buckets are being utilized below an under-utilization threshold or upon determining that a threshold number of buckets are being utilized above an over-utilization threshold. For example, if there are five buckets and two buckets have never stored any data, then the number of buckets may be reduced from five to four. In another example, if there are five buckets and all five buckets are storing data, then a sixth new type of bucket may be added to accommodate an additional type of data. The fourth logic 838 may also selectively reconfigure a storage parameter associated with a bucket upon determining that less than a lower threshold amount of data has been stored according to the storage parameter or upon determining that more than an upper threshold amount of data has been stored according to the storage parameter.

In one embodiment, apparatus 800 may be a computer, circuit, or apparatus located in an object store. In this embodiment, apparatus 800 and the object store may provide means (e.g., hardware, software, circuit) for partitioning an object store into a plurality of data stores. A member of the plurality of data stores is associated with a unique addressable namespace and a set of storage parameters. Apparatus 800 and the object store may provide means (e.g., hardware, software, circuit) for dynamically establishing the set of storage parameters for a member of the plurality of data stores. Apparatus 800 and the object store may provide means (e.g., hardware, software, circuit) for identifying a set of attributes for a file to be stored in a member of the plurality of data stores. Apparatus 800 and the object store may provide means (e.g., hardware, software, circuit) for selecting a member of the plurality of data stores to store the file based, at least in part, on a comparison of the set of attributes and the set of storage parameters for the member of the plurality of data stores.

While example systems, methods, and other embodiments have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and other embodiments described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A non-transitory computer-readable storage medium storing computer-executable instructions that when executed by a computer cause the computer to perform a method, the method comprising:
accessing data that is to be stored in an object store, where the object store is configured with two or more data destinations, where different data destinations have different data storage policies;
classifying the data by identifying a value for an attribute of the data;
selecting a data storage policy associated with a member of the two or more data destinations based, at least in part, on the value of the attribute, and
providing the data to a member of the two or more data destinations that is associated with the data storage policy.

2. The non-transitory computer-readable storage medium of claim 1, where classifying the data by identifying the value for the attribute includes examining metadata associated with the data or examining the contents of the data.

3. The non-transitory computer-readable storage medium of claim 2, where the attribute is a file type, a file size, a file owner, an origin of the data, an age of the data, or a velocity of the data.

4. The non-transitory computer-readable storage medium of claim 1, where the data storage policy describes a number of copies to be made of the data, whether the data is to be stored onsite, whether the data is to be stored offsite, whether the data is to be compressed, a type of compression to be performed on the data, whether the data is to be encrypted, or a type of encryption to be performed on the data.

5. The non-transitory computer-readable storage medium of claim 1, where the data storage policy controls whether the data will be stored using erasure codes.

6. The non-transitory computer-readable storage medium of claim 5, where the data storage policy controls a parity level used with erasure code based storage.

7. The non-transitory computer-readable storage medium of claim 1, where classifying the data is performed in an apparatus located external to the object store, where the object store exposes two or more namespaces to the apparatus located external to the object store, and where members of the two or more data destinations have unique namespaces.

8. The non-transitory computer-readable storage medium of claim 1, where classifying the data is performed in an apparatus located internal to the object store, where the object store exposes two or more namespaces to the apparatus located internal to the object store, where the object store exposes a single namespace to apparatus located outside the object store, and where members of the two or more data destinations have unique namespaces.

9. The non-transitory computer-readable storage medium of claim 1, where classifying the data is performed in-line in an apparatus integrated into the object store, where the object store exposes two or more namespaces to the apparatus integrated into the object store, where the object store exposes a single namespace to apparatus located outside the object store, and where members of the two or more data destinations have unique namespaces.

10. The non-transitory computer-readable storage medium of claim 1, where providing the data to the member includes providing the data directly to the member.

11. The non-transitory computer-readable storage medium of claim 1, where providing the data to the member includes sending the data to the member indirectly via an intermediate data store.

12. The non-transitory computer-readable storage medium of claim 11, the method comprising controlling a separate process to move the data from the intermediate data store to the member.

13. The non-transitory computer-readable storage medium of claim 12, the method comprising:
selectively triggering the separate process periodically or upon determining that a threshold amount of data is being stored in the intermediate data store.

14. The non-transitory computer-readable storage medium of claim 1, the method comprising:
selectively adding a new data destination to the two or more data destinations, where adding the new data destination includes providing an additional data storage policy associated with the new data destination, or
selectively removing a data destination from the two or more data destinations, where removing the data destination includes deactivating a data storage policy associated with the data destination being removed.

15. The non-transitory computer-readable storage medium of claim 1, the method comprising:
selectively modifying a data storage policy based, at least in part, on an observation of a threshold amount of data that has been stored in the object store.

16. An apparatus, comprising:
a processor;
a memory;
a set of logics that control storage of data in an object store configured with two or more buckets, where the set of logics cause an item to be stored in a member of the two or more buckets based, at least in part, on a set of data classifications; and
an interface that connects the processor, the memory, and the set of logics;
the set of logics comprising:
a first logic that produces a classification of the item to be stored by the object store;
a second logic that selects a bucket from the two or more buckets based, at least in part, on the classification; and
a third logic that controls the item to be provided to the bucket.

17. The apparatus of claim 16, where the first logic produces the classification from the contents of the item or from metadata associated with the item.

18. The apparatus of claim 17, where the second logic selects the bucket by matching the classification to storage parameters associated with members of the two or more buckets.

19. The apparatus of claim 18, where the third logic controls the item to be provided to the bucket indirectly via a network attached storage.

20. The apparatus of claim 17, comprising a fourth logic that:
selectively reconfigures the number of buckets available in the object store upon determining that a threshold number of buckets are being utilized below an under-utilization threshold or upon determining that a threshold number of buckets are being utilized above an over-utilization threshold, and
selectively reconfigures a storage parameter associated with a bucket upon determining that less than a lower threshold amount of data has been stored according to the storage parameter or upon determining that more than an upper threshold amount of data has been stored according to the storage parameter.

21. An object store, comprising:
means for partitioning an object store into a plurality of data stores, where a member of the plurality of data stores is associated with a unique addressable namespace and a set of storage parameters;
means for dynamically establishing the set of storage parameters for a member of the plurality of data stores;
means for identifying a set of attributes for a file to be stored in a member of the plurality of data stores; and
means for selecting a member of the plurality of data stores to store the file based, at least in part, on a comparison of the set of attributes and the set of storage parameters for the member of the plurality of data stores.
